(19) United States
(12) Patent Application Publication
(10) Pub. No.: US 2007/0284943 A1
(43) Pub. Date: Dec. 13, 2007

(54) RF-immobilizer and contactless ignition for a motor vehicle

(76) Inventor: John Meeks, Mason, OH (US)

Correspondence Address: WILLIAM B RITCHIE;LAW OFICE OF WILLIAM B. RITCHIE, 413 NOBLE FAIRE DRIVE, SUN CITY CENTER, FL, 33573, US

(21) Appl. No.: 11/725,581

(22) Filed: Mar. 19, 2007

Related U.S. Application Data
(60) Provisional application No. 60/784,300, filed on Mar. 20, 2006.

(51) Int. Cl. B60R 25/04

(52) U.S. Cl. 307/10.3

(57) ABSTRACT

A contactless ignition and RF immobilizer for use with motor vehicle ignition systems. The apparatus uses many of the prior art components, however, it eliminates the need for a metal cylinder that contacts a key blade. Instead, a plastic cylinder with a magnet is provided that will activate at least two reed switches to achieve the various ignition system positions. The blade of the key merely functions to open the door and trunk locks. Since the reed switches are very small, additional switches could be added to measure tire pressure, keyless entry and a host of other functions, if they are all placed within the operating range of the molded RF antenna.

This application claims benefit under Title 35 USC, §119(e) of U.S. Provisional Application Ser. No. 60/784,300 filed Mar. 20, 2006.

### FIELD OF THE INVENTION

The invention relates to a motor vehicle ignition locking system namely, ignition locks using an RF transponder to verify that the operator is authorized to start the motor vehicle.

### BACKGROUND AND SUMMARY OF THE INVENTION

Since the advent of the automobile, an ignition key and cylinder lock was immediately found necessary to prevent unauthorized personnel from using or stealing the vehicle. A keyed lock was the first method of choice. Using this method, a blank key having at least one channel is ground at predetermined places along the blank key. The fob of the key merely serves to turn the key in the lock.

In order to open, a plurality of pins in the lock corresponds to the cuts in the key blank. In order for the lock to open, these pins must fall a distance corresponding to the depth of the key blank at various points so that the pins line up and cylinder lock is permitted to turn.

This system clearly has substantial deficiencies. The number of variations of keys is dependent upon the diameter and number of pins. Slight variations in copies can keep the new key from working easily or at all. Eventually, the key turning within the cylinder cause deformation of the key relative to the lock or bending the blade of the key slightly can cause the lock to fail. This is a relatively expensive solution given the minimal security that is provided.

While this lock and key method or variations thereof are still used extensively, it is found usually only with pass door sets, lawn mowers, padlocks, etc. wherein the day-to-day opening and closings are infrequent and where the device primarily helps to keep ‘honest people honest.’

Shown in FIG. 1 is an illustration of a typical improvement of the steering wheel lock and ignition mechanism. This is the type that is used on present day Honda Civic automobiles as well as others. In this device, a combination of a key blade is used with RF immobilizing circuitry.

The metal steel wheel and ignition system is bolted onto vehicle threaded openings, only one of which is depicted. Note that in a typical steering lock and ignition mechanism 10, a metal cylinder 12 that must be turned by an ignition key with the tumblers lined up in order to be able to move from one point on the key position bezel 32 to the next one.

The second major component of this apparatus is immobilizer assembly 30 which features a plastic housing which is bolted to the motor vehicle and steering wheel lock and ignition assembly 10 via representative openings.

The immobilizer assembly 30 is manufactured of molded plastic parts that are bolted to the steering wheel lock and ignition mechanism 10. As shown in FIG. 2, RF antenna 38 is actually molded in the key position bezel 32. RF circuitry 26 is placed inside immobilizer assembly 30 so that in order to enable the auto electronics i.e. electronic fuel pump and engine electronic control module, etc., the appropriate code must be transmitted from the fob 44 via antenna 38 to the RF circuitry 26. Then, a new pair of code identifiers is randomly prepared with one set being sent to the fob 44 and the other remaining in the RF circuitry 26 so that the unit is rearmed for the next use.

Rather than scores of possibilities that are made possible by a key and tumbler device, this apparatus permits tens of thousands of combinations so that it is highly unlikely that any two keys and their corresponding RF circuitry ever use the same pair at the same time.

As shown in FIG. 2, an electronic connector 34 from the RF circuitry 26 is electrically connected to the locking and ignition mechanism and antenna 38 to enable the device to function as described.

The molded RF antenna 38 is encapsulated or molded into key position bezel 32, cover plate 24 snaps over the RF circuitry 26 and then is placed into housing assembly 30, which, in turn, is bolted to locking and ignition mechanism 10 to complete the assembly.

In spite of the improvements mentioned above, the prior art still has the requirement of a metal key that must have contact with the metal cylinder. This system while it does provide a greater number of codes and thus greater security, it stills suffers from the fact that the reliability of the unit is only as good as the blade of the key that is inserted therein. Therefore, what is not found in the prior art is a contactless RF immobilizer and ignition system that also reduces the weight of the system by eliminating the metal cylinder; reduces the material costs; reduces installation labor; provides for remote location of key cylinder and immobilizer antenna i.e. dash board or console and eliminates the need for the metal key blade and for the mechanical cylinder lock.

### SUMMARY OF THE INVENTION

Therefore one aspect of the present invention is to utilize as many parts of the prior art device as possible so that the invention can be installed without requiring major changes in the dash board or other major structural components of the motor vehicle.

Another aspect of the present invention is to use reed switches which are magnetically activated and hermetically sealed contacts thus providing a contactless ignition switch.

Still another aspect of the invention is to provide an RF immobilizer circuitry that eliminates the need for the mechanical cylinder lock.

Another aspect of the invention is to provide an RF immobilizer for a motor vehicle that has reduced weight when compared to its prior art counterpart.

Another aspect of invention is to provide an RF immobilizer for a motor vehicle that has improved reliability due to the metal-to-metal contacts in the cylinder and key being eliminated.

Another aspect of the present invention is to provide for the remote location and simplify the installation away from the steering column.

Another aspect of the present invention is to provide an RF immobilizer for a motor vehicle that will reduce component parts and reduce the number of suppliers that must be found.

Yet another aspect of the present invention is to provide an RF immobilizer for a motor vehicle that reduces material costs.

Another aspect of the present invention is to provide an RF immobilizer for a motor vehicle that reduces installation labor.

These and other aspects of the invention will become apparent in light of the detailed description of the invention which follows.

### BRIEF DESCRIPTION OF THE DRAWINGS

FIG. 1 is an isometric illustration of a partially exploded view of a prior art steering wheel lock and ignition mechanism including an RF immobilizer assembly.

FIG. 2 is a partially exploded isometric illustration of the prior art immobilizer assembly.

FIG. 3 is a partially exploded isometric illustration of the immobilizer assembly in accordance with the invention.

FIG. 4 is an illustration of the key as used to activate the invention shown in FIG. 3.

FIG. 5 is an illustration of the front view of the invention with part of the immobilizer housing removed for clarity.

FIG. 6 is an illustration of the top view of the antenna and ignition switch connector, the reed switches and plastic cylinder, etc. with a portion of the immobilizer housing partially removed from the immobilizer assembly for clarity.

FIG. 7 is a cutaway illustration showing the key slot at position “zero”.

FIG. 8 is a cutaway illustration showing the key slot at position “I”.

FIG. 9 is a cutaway illustration showing the key slot at position “II”.

FIG. 10 is a cutaway illustration showing the key slot at position “III”.

### DETAILED DESCRIPTION OF THE PREFERRED EMBODIMENTS

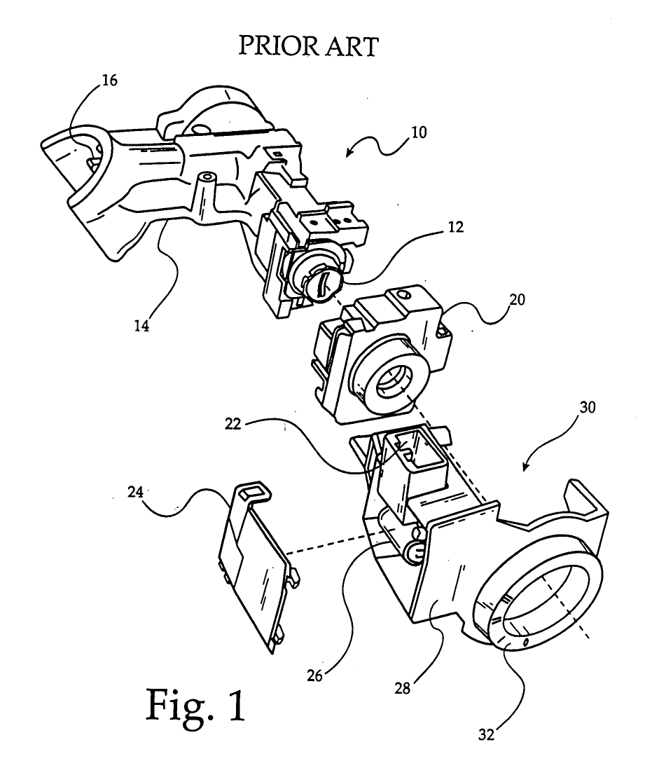

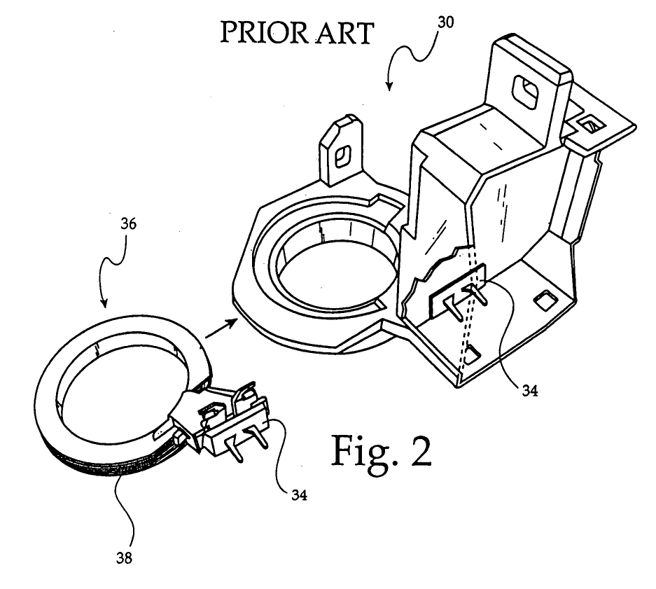

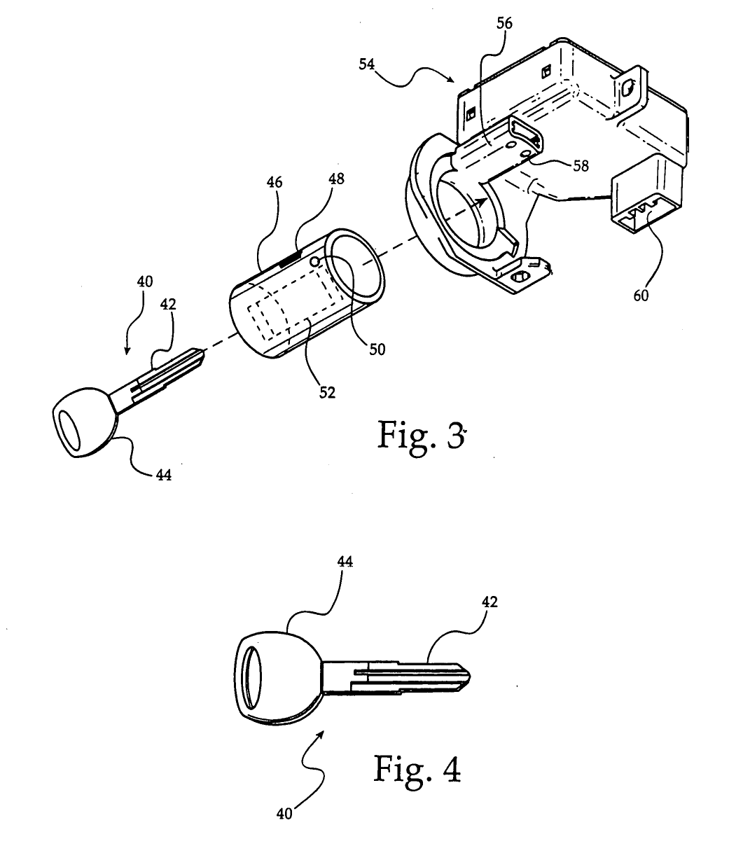

FIG. 3 illustrates the preferred embodiment of the invention. Note that the immobilizer assembly 54 of the invention is similar to the immobilizer assembly 30 of the prior art as shown in FIG. 1. However, some novel critical improvements are now included in the immobilizer assembly 54. As will be discussed below, the contact ignition switch has been replaced by magnetically activated reed switches that eliminate the need for a metal key and metal lock cylinder 12. There is also a need for a solenoid (not shown) that will release the steering wheel lock pin 16.

The metallic cylinder 12 has been replaced by a plastic key cylinder 46. Note that blade 42 of key 40 serves to merely rotate the plastic key cylinder 46 when the blade 42 is inserted into key slot 52. There are no corresponding tumblers or pins or any type of pins located in plastic key cylinder 46. And, in fact, plastic key cylinder 46 can be easily rotated with any piece of any material such as a screw driver that would fit into key slot 52. Within key fob 44, as in the prior art, electronic circuitry is present that provides a code to release the immobilizer circuitry within immobilizer assembly 54. No electrical power in key fob 44 is required.

A small capacitor within key fob 44 is charged via a 128 KHz burst that is sent via the wire coil 38, thus, briefly charging the capacitor (not shown) within key fob 44. Wherein one half of the code is sent back to the RF circuitry to see if they match just as in the prior art. If they do, then the circuitry is released and, virtually simultaneously, a new matching code pair is prepared with one coded set of signals being sent to key fob 44 and the other held within the RF immobilizer circuitry. Again, this part of the invention is ritually identical to that of the prior art. The essence of the invention is the elimination of the contacts between a metal key and metal cylinder as these structures play no role in the invention. Once the RF circuit immobilizer has been released, the ignition may be activated at the various position points which will be discussed below.

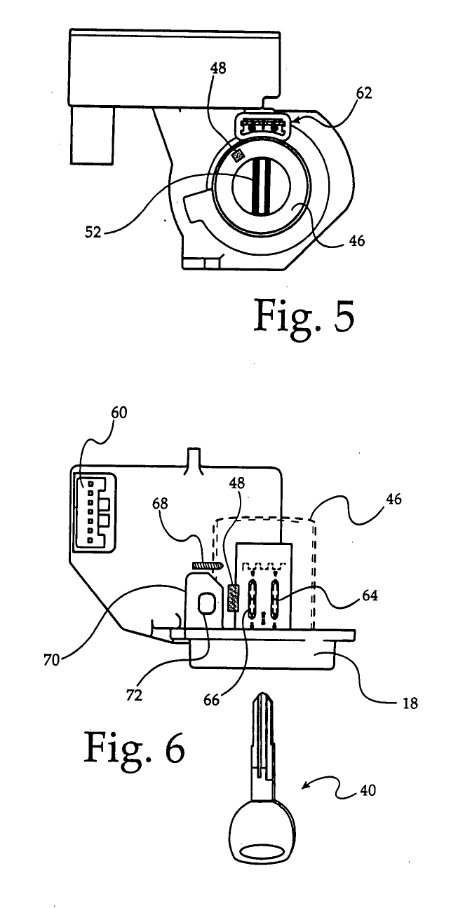

FIG. 5 is a partial cut-away view showing the key slot 52, the plastic cylinder 46 and the magnet 48 and reed switch 62.

FIG. 6 is a top view of the immobilizer housing and the critical components located therein. Magnet 48 on the cylinder 45 shows how it lines up with reed switches 64 and 66. Electronic connector 60 connects the RF antenna 36 and shows the ignition switch position as provided by the status of reed switch 64 and reed switch 66.

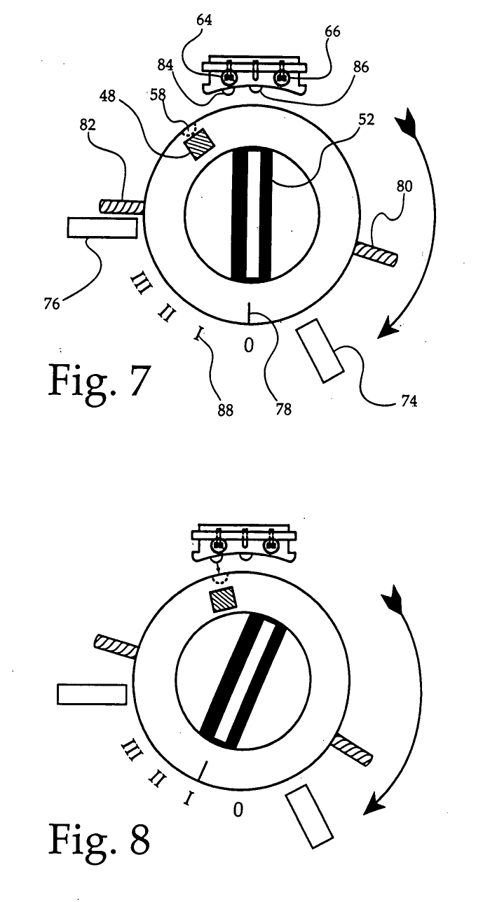

Stop screw 68 merely keeps cylinder 46 from rotating beyond a desired counter clockwise point. This becomes clearer when the various position indicators 78 of key position bezel 32 are described in detail in FIGS. 7 thru 10.

In each of the four mentioned figures, it is apparent that the rotating key bezel 32 enables the magnet to ‘open’ and ‘close’ reed switch 64 and reed switch 66. Recall that a reed switch is always ‘open’ until it encounters a sufficient magnetic field to cause it to ‘close’.

In FIG. 7, the position indicator of the key slot 52 is in the ‘off’ condition. Note that detent receiver 58 corresponds to detent 84 and detent 86. Note that there is no detent for position ‘zero’ but one could be added just to provide a positive feel when the switch is turned ‘off.’

Also note that in FIG. 7, stop screw 82 is immediately adjacent against stop 76 thus providing the maximum counter clockwise rotation of cylinder 46.

Further, since magnet 48 is not close to either reed switch 64 or reed switch 66; therefore, both of these switches remain ‘open.’

As shown in FIG. 8 the key slot has been rotated slightly clockwise so that cylinder 46 is now lined up with detent receiver 58 being occupied by detent 84. Typically, position indicator “I” is provided and this corresponds to turning on the accessory lights, etc. for the motor vehicle.

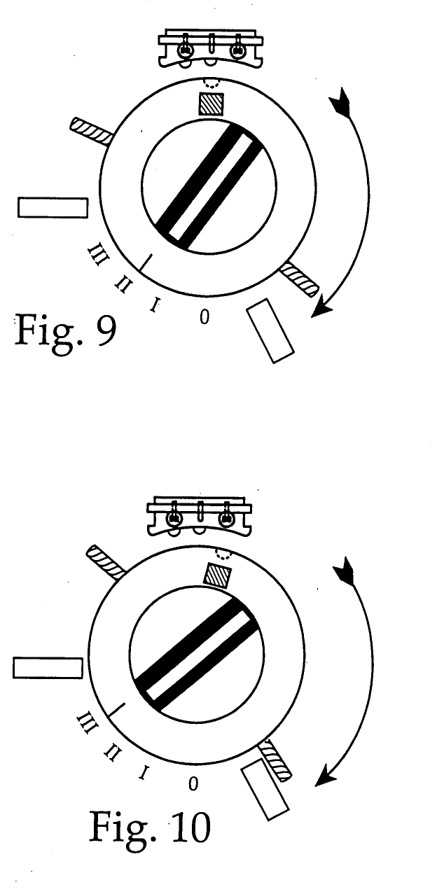

Moving on to FIG. 9, bezel 86 is further rotated clockwise to position “II”. In this position, bezel 86 is now engaged in detent receiver 58 and magnet 18 is now halfway between reed switch 64 and reed switch 66 which provides sufficient magnetic field to close both switches. In this position, a motor vehicle is typically set with the ignition ‘on’. Further rotation, as shown in FIG. 10, is the maximum clockwise rotation and corresponds to position ‘III’. Position III shows that neither detent 84 nor 86 are in engaged with detent receiver 58. A second stop 80 is immediately adjacent to stopper 74 thus preventing further clockwise rotation. In this position, reed switch 64 is ‘open’ and reed switch 66 is now ‘closed.’ This corresponds to the ‘starter’ being activated and as soon as the engine starts, the key is placed back to the position shown in FIG. 9.

It should be noted that this particular invention permits all kinds of variations not possible by using a metal cylinder with a key. First, blade 42 can be made superfluous by merely placing a card or icon that contains the circuitry in fob 44 near the RF antenna 36. That will be sufficient to make the appropriate electrical connections to mobilize the circuitry. Then, bezel 86 can merely be rotated by hand without the need for a blade or key of any type. Other arrangements such as buttons or switches, etc. could also be used. Due to the fact that the reed switch occupies such a small arc around the cylinder, a substantial number of reed switches could be provided. This would permit measuring tire pressures, keyless entry, opening a sun roof, adjusting seats; unlock a gas cap, opening a trunk, etc.

While certain representative embodiments of the invention have been described herein for the purposes of illustration, it will be apparent to those skilled in the art that modification therein may be made without departure from the spirit and scope of the invention.

What is claimed is:

1. A contactless key ignition apparatus for a motor vehicle comprising:
a plurality of reed switches which are magnetically activated and have hermetically sealed contacts;
an antenna;
a RF immobilizer circuit associated with said plurality of reed switches and said antenna that eliminates the need for a mechanical cylinder lock;
wherein said reed switches can be activated from a remote location and wherein an antenna electronically connected to said RF immobilizer circuit prevents unauthorized entry to the vehicle;
a plastic cylinder that selects the desired reed switches to be activated;
a key blade that it is used merely to rotate the plastic cylinder such that magnets attached to said cylinder duplicate the same vehicle operation conditions as is found using a keyed entry.
